(19) United States
(12) Patent Application Publication
(10) Pub. No.: US 2025/0077832 A1
(43) Pub. Date: Mar. 6, 2025

(54) PERSONALIZED ARTIFICIAL INTELLIGENCE PLATFORM

(71) Applicant: Christopher Sonn, Chestnut Hill, MA (US)

(72) Inventor: Christopher Sonn, Chestnut Hill, MA (US)

(21) Appl. No.: 18/241,141

(22) Filed: Aug. 31, 2023

(51) Int. Cl. G06N 3/04

(52) U.S. Cl. CPC G06N 3/04

(57) ABSTRACT

The present invention discloses a Personalized Big Data and Artificial Intelligence Container (pAI), which is a revolutionary platform that integrates personal big data and AI algorithms to enhance individuals' web experiences. The pAI platform employs advanced machine learning algorithms, neural networks, and natural language processing techniques to preserve and process personal data, enabling customized and tailored interactions with external systems. By analyzing target systems and providing essential personal information, the pAI platform optimizes and fine-tunes interactions, resulting in highly personalized and effective outcomes for users. This patent application provides a comprehensive disclosure of the pAI platform's functionalities, components, and potential applications.

### BACKGROUND OF THE INVENTION

The field of artificial intelligence and online platforms has witnessed remarkable advancements, revolutionizing various aspects of human life. However, conventional artificial intelligence systems and commercial platforms have operated without integrating personalized end-user knowledge, leading to limitations in the quality and efficiency of online services. The lack of personal knowledge compromises the web experience, as individuals receive generalized responses and recommendations, irrespective of their unique preferences, interests, and context. The present invention addresses these drawbacks by introducing a pioneering personalized artificial intelligence platform, the Personalized Big Data and Artificial Intelligence Container (pAI). By leveraging personal big data and advanced AI algorithms, the pAI platform enables the preservation, optimization, and processing of personal knowledge. This platform empowers individuals to have personalized and tailored experiences when interacting with the web and other AI systems.

### FIELD OF THE INVENTION

The present invention relates to the field of artificial intelligence, big data, and personalized web experiences. More specifically, the invention pertains to a neural network-based personal data container technology that gathers and retains personal big data and AI algorithms to process the data for individual users. The platform enables the preservation and processing of personal knowledge, facilitating customized and personalized interactions with the World Wide Web (WWW) and other AI systems.

### BRIEF SUMMARY OF THE INVENTION

The Personalized Big Data and Artificial Intelligence Container (pAI) is a groundbreaking platform that seamlessly integrates personal big data and AI algorithms to enhance web experiences. The platform employs machine learning algorithms, neural networks, and natural language processing techniques to preserve and process personal data, allowing for customized and personalized interactions with external systems. By analyzing target systems and providing essential personal information, the pAI platform optimizes and fine-tunes interactions, resulting in highly tailored and effective outcomes for the users.

### BRIEF DESCRIPTION OF THE DRAWINGS

FIG. 1-FIG. 1 depicts a flow chart of the personalized AI platform.

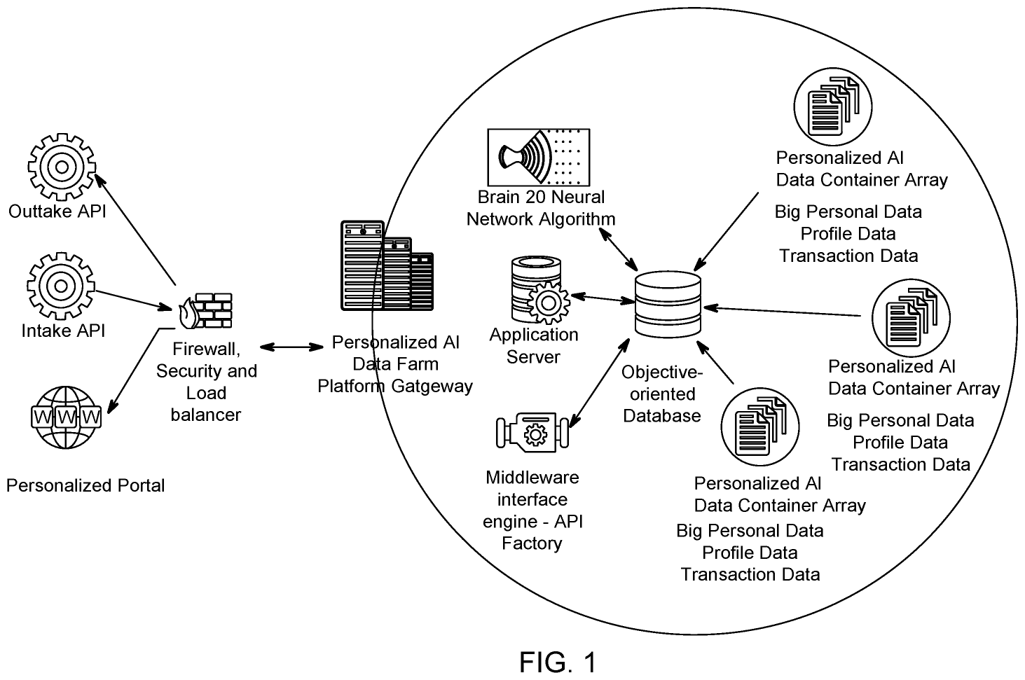

### DETAILED DESCRIPTION OF THE INVENTION

The Personalized Big Data and Artificial Intelligence Container (pAI) comprises an intricate system of interconnected clusters and cutting-edge functionalities. The following description provides a comprehensive disclosure of the invention's components, processes, and potential applications.

In one embodiment, the pAI platform includes a Data Gather and Input cluster responsible for continuously receiving personal data from various sources. The personal data encompasses web browser history, learning history, multimedia inputs (including voice, video, and image data), personal profile, preference metadata, health information, financial data, purchase history, personal growth, and intellectual learning. This comprehensive data gathering ensures a comprehensive representation of the individual's preferences, interests, and contextual information.

The pAI platform further encompasses a Data Store and Neural Network-Based Processor cluster, which efficiently stores and processes personal big data. Advanced machine learning algorithms and neural networks are employed to optimize data classification, retrieval, and analysis. An AI-optimized taxonomy is employed for organizing and categorizing the personal data, facilitating efficient storage, retrieval, and utilization.

The pAI platform includes an Output/Interactive cluster that enables seamless interactions with external systems based on the processed personal data. Through advanced natural language processing techniques, the platform extracts relevant information from the personal database and utilizes it to interact with external systems. This enables highly personalized and tailored interactions, ensuring that the external systems can fine-tune and optimize their interactions with the user.

The pAI platform incorporates natural language processing capabilities to extract meaningful information from the personal database. By leveraging sophisticated linguistic analysis and semantic understanding, the platform enables personalized interactions with external systems, improving the overall web experience for the user. The natural language processing component plays a vital role in understanding user queries, extracting relevant information, and generating appropriate responses.

The pAI platform can serve as a foundation for various extensible personalized platforms that harness its capabilities. For instance, the platform can be utilized for digital cryogenics, preserving an interactive personality in the form of a virtual avatar for future generations. By encapsulating personal knowledge, preferences, and characteristics, individuals can leave a lasting and interactive presence that transcends time.

Furthermore, the pAI platform enables the creation of virtual avatar personas with replicated AI. These virtual representations can mimic the characteristics and expertise of renowned professionals, such as psychologists. Through assimilated therapy methods and workflows, individuals can interact with these virtual avatars, benefiting from personalized therapeutic experiences tailored to their unique needs.

The pAI platform encompasses a personalized portal that allows users to manage their personal profile, configure security levels and data interchange parameters, monitor their learning and intellectual growth status, and control the interest data gathering and delivery based on AI agents. The personalized portal provides a centralized interface for users to interact with the pAI platform, ensuring a seamless and intuitive user experience.

The pAI platform incorporates a personalized search module that leverages the preserved personal big data to deliver highly relevant and tailored search results. By understanding the user's preferences, context, and past interactions, the search module enhances the accuracy and efficiency of search queries, improving the overall web browsing experience.

The pAI platform further includes a financial, health, and web-triggered AI proxy agent that acts as an intermediary between the user and external systems in specific domains. This agent leverages the personal big data to provide personalized recommendations, suggestions, and insights tailored to the user's financial status, health condition, and web browsing activities. The financial, health, and web-triggered AI proxy agent ensures that the user receives highly relevant and beneficial information, enhancing their decision-making and overall well-being.

1. A personalized big data and artificial intelligence platform, comprising:
A Data Gather and Input cluster configured to continuously receive personal data from multiple sources, including web browser history, learning history, and multimedia inputs;
A Data Store and Neural Network-Based Processor cluster designed to efficiently store and process the personal big data using machine learning algorithms and neural networks; and
An Output/Interactive cluster facilitating seamless interactions with external systems based on the processed personal data, enabling fine-tuning and optimization of interactions with users.

2. The personalized big data and artificial intelligence platform of claim 1, further comprising a Natural Language Processing component configured to extract relevant information from the personal database and enable personalized interactions with external systems.

3. The personalized big data and artificial intelligence platform of claim 1, wherein the Data Gather and Input cluster further collects and stores personal profile and preference metadata, health information, financial data, purchase history, and personal growth and intellectual learning data.

4. The personalized big data and artificial intelligence platform of claim 1, wherein the Data Store and Neural Network-Based Processor cluster utilizes an AI-optimized taxonomy for efficient storage, retrieval, and analysis of personal big data.

5. The personalized big data and artificial intelligence platform of claim 1, wherein the Output/Interactive cluster utilizes natural language processing techniques to extract relevant information from the personal database, enabling customized interactions with external systems.

6. A method for personalized big data and artificial intelligence platform, comprising:
Continuously receiving personal data from multiple input sources, including web browser history, learning history, and multimedia inputs;
Storing the personal data in a Data Store and Neural Network-Based Processor cluster using machine learning algorithms and neural networks; and
Analyzing target systems and providing essential personal information to optimize interactions with external systems.

7. The method of claim 6, further comprising extracting relevant information from the personal database using a Natural Language Processing component and utilizing it to interact with external systems.

8. The method of claim 6, further comprising collecting and storing personal profile and preference metadata, health information, financial data, purchase history, and personal growth and intellectual learning data.

9. The method of claim 6, wherein the Data Store and Neural Network-Based Processor cluster utilizes an AI-optimized taxonomy for efficient storage, retrieval, and analysis of personal big data.

10. The method of claim 6, wherein the Output/Interactive cluster utilizes natural language processing techniques to extract relevant information from the personal database, enabling customized interactions with external systems.
